(19) United States
(12) Patent Application Publication
(10) Pub. No.: US 2005/0080740 A1
(43) Pub. Date: Apr. 14, 2005

(54) Prospernomics

(76) Inventor: Boris Isaacson, Buckeye, AZ (US)

Correspondence Address: Boris Isaacson, 23886 W. Desert Bloom Street, Buckeye, AZ, 85326, US

(21) Appl. No.: 10/684,196

(22) Filed: Oct. 14, 2003

(51) Int. Cl. G06F 17/60

(52) U.S. Cl. 705/42; 705/43

(57) ABSTRACT

Prospernomics is a method of allowing new work to create new money, to keep consumption equal to production and to eliminate taxes and government fees. Workers are paid with a Special Money Creating Check by employers. This newly created money keeps the nation's money supply equal to the nation's production thereby insuring that consumption will always equal production. Such a system prevents recession and inflation and provides for maximum growth of the economy. Each time an employee is paid his or her employer's account is debited by a clearing house a like amount of money equal to his or her pay and sent proportionally to the four divisions of government eliminating the need for taxes and government fees. Such funding gives government approximately 5 times the revenue it gets under conventional taxation and provides that no division of government shall depend on any other division for funding.

2 Claims—I claim my Prospernomics invention will:
1. automatically keep consumption equal to production in any economy thereby assuring that economy stability and growth.
2. afford any government sufficient funding without the need for any taxes or government fees at no cost to anyone.

### BACKGROUND AND NEED FOR THE PROSPERNOMICS INVENTION

Economies around the world are constantly plagued with boom and bust, prosperity and recession. Considerable economic suffering including unemployment, poverty, recession, bankruptcy, foreclosure, repossession, homelessness and limited economic growth are the result of current economies because they have no way to keep consumption equal to production. Unemployment, poverty, recession, bankruptcy, foreclosure, repossession, homelessness and limited growth are at an all time high with no end or improvement in sight.

The common problem with current economies is that the money supply is always out of balance with production. Too much money in circulation causes inflation. Too little money in circulation causes recession which in turn causes unemployment, poverty, bankruptcy, foreclosure and homelessness and restricts economic growth. No economy will be successful until a process is in place that will insure that consumption will always equal production. Today current economies have no way to keep consumption equal to production. Prospernomics will always keep consumption equal to production.

Taxes have always been a deterrent to economic prosperity because taxes unduly reduce purchasing power of consumers. Taxes, the conventional method of funding government, not only restricts trade and economic growth but taxes have proven that taxes do not sufficiently fund governments which is evidenced by massive current government debt world-wide. Taxes are a major contributing cause of conditions that perpetuate increased unemployment, poverty, bankruptcy, foreclosure and homelessness while they restrict economic growth. Taxes are not an acceptable or adequate means for government support because they can not provide sufficient funding without depleting the money supply creating a downward spiral of effects ending in unemployment, poverty, bankruptcy, foreclosure and homelessness and restricted economic growth. The Prospernomics invention solves this problem.

Prospernomics: Claim 1—Prospernomics Insures Consumption Will Equal Production

The process, named Prospernomics, embodied in this patent application will make it possible for any economy to have consumption and production always equal, thereby avoiding both booms and busts. The Prospernomics process will measurably contribute to prosperity and full employment and will greatly reduce poverty, bankruptcy, foreclosure and homelessness while it allows unlimited growth of the economy.

Prospernomics: Claim 2—Prospernomics will eliminate the need for any taxes or government fees and more than adequately supply funding for government at zero cost to anyone. Government will be able to operate without borrowing money. The government will get the same amount of money as the combined total of all work paid for, approximately 2 to 5 times the revenue produced by current taxes.

Because all raw materials come from nature, and because you can not pay nature, all value, wealth, of all goods and services is derived only from the work done on raw materials and products made from those raw materials. Work and only work creates wealth or value because without work nothing can have value. Prospernomics is a process whereby work, the creator of value, will create the money to purchase the value that the work creates. All new work creates new value and all new work under Prospernomics will create new money equal to the value created by the new work. As new work is done new value is created and as Prospernomics allows the creation of new money equal to all new work the money supply will always equal production allowing a perfect equality between production and consumption.

1. Special Paychecks Create Money:

All work must be paid for by a Special Money Creating Check from an employer's bank. No work may be paid for in any other way. Anyone who hires employees must have a bank account and must pay their employees with the above mentioned Special Money Creating Check.

2. Work By Employees:

Work is done by an employee. The employee is paid by his employer using a Special Money Creating Check that allows the employee's bank to create the money by entering into the employee's bank account a credit equal to the amount on the employee's Special Money Creating Check. No charge is made to the employer's bank account at this point. Such a check may look something like the following example, though varying configurations of the same concept could be developed.

[image]

3. No other money may be created:

No new money may be created in any other way, form or process. To keep the money supply equal to production, thereby allowing consumption to equal production, no money should be allowed to be created in any other fashion or process. Creating new money in any other way will upset the equality between consumption and production.

4. Employer's bank account is debited by clearing house:

Up to this point no funds were debited from the employer's bank account. After the money was created into the employee's bank account the empoyee's bank sends the Special Money Creating Check to the clearing house and the clearing house debits the employer's bank account the same amount as the amount on the Special Money Creating Check given to the employee and sends the money to the government.

5. Distribution of Prospernomics Revenue to Government:

There are four divisions of government that need to be funded by Prospernomics. They are, here in the United States, federal, state, county and city governments. By adding all the current taxes collected by all four divisions of government together we arrive at a total tax collected for the nation. By simple arithmetic we can arrive at the percentage that each division of government should receive from the total Prospernomics revenue. If for example the federal government received 47% of all taxes collected then the federal government would get 47% of the Prospernomics revenue. In countries where different divisions of government exist a similar arithmetiucal division of the Prospernomics revenue could be accomplished.

6. Automatic Collection and Distribution of Revenue:

No single division of government should collect the revenue from Prospernomics. If any one division of government collected the Prospernomics revenue then all the other divisions would be looking to that division for funding. No division of government should look to any other division of government for its funding. By pre-determining the percentages that each governmental division should get each of the four divisions of government can receive their share of the Prospernomics monies automatically from the clearing house. As each employer's account is debited each of the divisions of government will receive their fair share.

7. Small businesses and Self-employed Also Participate:

When a small business owner pays himself for the work he has done running his business he will pay himself with the same Special Money Creating Check. When ever Joe takes profits out of the business such withdrawal of profits are the same as his pay for running his business and will be treated the same as any other work done. Funds from the business owner's account will be debited and sent to the government the same as when the employee is paid. There really is no difference between a sole proprietor and an employee in operating the Prospernomics system.

8. Corporations participate:

Corporations will pay employees as explained in “1” above. Executives will also be paid the same way.

9. Investors will also participate:

An investment is a purchase with the expectation of gain. Like any other purchase investments are made with existing money, not new money. However, when a profit is made on an investment that profit is a direct result of the investor's efforts, however little time they may have consumed. That profit is a result of the investor's work using his investment money. The profit should be treated as payment for work done and be paid for with a Special Money Creating Check. New money should be created to compensate the investor and a like amount goes to the government directly from the company the investment was made in.

10. Losses Are Treated in Prospernomics:

When an investment ends up as a loss it is no different than a shopkeeper having to discard obsolete or goods that are spoiled and cannot be sold. No, there is not much difference in these two examples. The goods the shopkeeper has to dispose of should not and do not affect Prospernomics. And in the same manner the loss resulting from an investment should not affect Prospernomics revenue.

11. Sales of Products and Services:

When a product or service is sold, aside from the salesperson's own work in making the sale, no new money needs to be created. When a customer buys a product or service he or she is spending existing money. No new money is involved in the purchase. Yes, the salesperson has done work in making the sale and new money will be created through Prospernomics when he or she is paid salary or commission.

11. Commissions Are Wages:

Commissions are compensation for sales made. Sales made are the same as work done. While the commission may be made in minutes, hours, or days, time is not a factor. When the commission is paid it should be treated under Prospernomics as work done and paid for with a Special Money Creating Check.

12. Government Employees Under Prospernomics:

Government employees are different than other employees. While their work is very essential and valuable it does not add to the marketplace or the total marketable wealth of the nation. The wealth of the nation is the total of all saleable goods and services. Government employees do not add value to saleable goods or services and therefore their work should not create new money. They, very logically, should be paid for with the money turned over to the government from all the marketable work done by people in the private marketable sector. If government employees were paid with “new” money the money supply would be overly increased and cause inflation. In this way the monies collected by government will not become inflationary and the balance between production and consumption will remain equal.

13. Government Purchases

Government purchases of goods, services, real estate, etc. are no different than purchases made by individuals. All purchases do not create new money and are bought with existing money.

14. Gifts and Inheritances:

Gifts and inheritances are not work, do not create new money, and are paid for with existing money. Gifts and inheritances should have no effect on Prospernomics. The free exchange of existing money should not be impaired. The free exchange of existing money does not alter the total wealth of anything.

15. Education Under Prospernomics:

Educators, teachers, coaches, etc. work with students and are paid the same as any other employees. However, the work students do in getting their education can not be paid with new money because they would then become “saleable” which is against the laws outlawing slavery. Only products and services fall under the concept of wealth creating and therefore money creating activities.

1. The invention provides a method for keeping consumption equal to production to produce a stable economy free from recession and inflation, and eliminates the need for taxation.
a. Prospernomics allows work, the creator of wealth, to create new money whenever new work is done thereby allowing
b. Prospernomics to keep the money supply equal to production which, in turn,
c. keeps consumption equal to production which
d. prevents recession
e. and prevents inflation and
f. establishes a stable economy
g. free to grow much faster than current economies.
h. Employers pay employees with a special money creating check, physically or electronically.
i. The new money created by the special money creating checks pay workers for their work, and
j. Increases the nation's money supply to keep it equal to production.
k. An equal amount of money that would normally be paid by employers to employees is debited from the employer's bank through a clearing house and sent to the four divisions of government, federal, state, county and city,
l. using a predetermined percentage equal to the percentage of the total tax revenue that each division of government gets with conventional taxation so that
m. no division of government will be dependent on any other division of government for its funding and
n. all divisions of government will receive funding continuously throughout the year.
o. Governments will receive about five times more revenue under Prospernomics than they receive under conventional taxation.
j. Prospernomics ends the need for taxes and government fees.
